(19) United States
(12) Patent Application Publication
(10) Pub. No.: US 2012/0242166 A1
(43) Pub. Date: Sep. 27, 2012

(54) SYSTEM FOR TRANSMITTING ELECTRIC POWER FROM A WALL TO A LEAF HINGEABLY FASTENED TO SAID WALL

(75) Inventors: Tibor Herglotz, Kreuzau (DE); Ingo Steinfeld, Langenfeld (DE); Wolfgang Staude, Waldeck (DE); Walter Hahn, Moenchengladbach-Wickrath (DE)

(73) Assignees: STAUDE KUNSTSTOFFTECHNIK GMBH, Bad Arolsen (DE); DR. HAHN GMBH & CO. KG, Moenchengladbach-Wickrath (DE)

(21) Appl. No.: 13/512,893

(22) PCT Filed: Oct. 4, 2010
(86) PCT No.: PCT/EP10/64730

§ 371 Date: May 31, 2012

(30) Foreign Application Priority Data
Dec. 2, 2009 (DE) 10 2009 044 729.6

(51) Int. Cl. H01F 38/14

(52) U.S. Cl. 307/104

(57) ABSTRACT

A system for transmitting electric power from a wall to a leaf hingeably fastened to the wall about a hinge axis includes a wall part fastened on the wall. A leaf part is fastened on the leaf. A primary coil is provided on the wall part. A secondary coil is provided on the leaf part. Primary electronics are configured to convert a power supply voltage into a primary voltage so as to act upon the primary coil. The primary voltage is suitable to generate a secondary voltage in the secondary coil by an inductive coupling. Secondary electronics are configured to convert the secondary voltage into an electric operating voltage suitable for at least one of an electric power supply mechanism and an electric consumer.

### CROSS REFERENCE TO PRIOR APPLICATIONS

This application is a U.S. National Phase application under 35 U.S.C.§371 of International Application No. PCT/EP2010/064730, filed on Oct. 4, 2010 and which claims benefit to German Patent Application No. 10 2009 044 729.6, filed on Dec. 2, 2009. The International Application was published in German on Jun. 9, 2011 as WO 2011/067011 A1 under PCT Article 21(2).

### FIELD

The invention provides a system for transmitting electric power from a wall to a leaf hingeably fastened to the wall about a hinge axis S.

### BACKGROUND

Hinges used for hinge-type connection of a leaf to a wall are known and are described, for example, in from DE 93 02 652 U1. They have also proven successful in a variety of different technical embodiments, also being used on doors for objects such as houses, businesses or escape doors.

To an increasing extent, such doors are equipment items that improve safety or convenience and are operated by electric power.

These items of equipment are connected by flexible cables to an external power source for the electric power supply.

These cable connections have a significant negative effect on the visual appearance and may become clamped between the leaf and the wall, which may result in damage or even destruction of the cable.

DE 10 2004 017 341 A1 describes a hinge having an installed transformer for a contactless energy transmission. This hinge comprises a primary coil arranged in a frame hinge part and a secondary coil arranged in a leaf hinge part. A hinge bolt passing through both coils serves to provide magnetic coupling of the secondary coil to the primary coil, which are spaced a distance apart from one another in the direction of the hinge axis.

Contactless energy transmission from a stationary frame to a leaf arranged pivotably on the frame would be fundamentally desirable in order to avoid the above-mentioned disadvantages, but experiments have shown that only a very low electric power level can be transmitted from the primary side to the secondary side using the equipment described in DE 10 2004 017 341 A1 because the power loss in transmission is high.

### SUMMARY

An aspect of the present invention is therefore to provide a system for transmitting electric power from the wall to a leaf hingeably mounted on the wall about a hinge axis in order to provide a contactless transmission of electric power with at least the power required to charge an electric power storage mechanism and/or for an electric consumer.

In an embodiment, the present invention provides a system for transmitting electric power from a wall to a leaf hingeably fastened to the wall about a hinge axis which includes a wall part fastened on the wall. A leaf part is fastened on the leaf. A primary coil is provided on the wall part. A secondary coil is provided on the leaf part. Primary electronics are configured to convert a power supply voltage into a primary voltage so as to act upon the primary coil. The primary voltage is suitable to generate a secondary voltage in the secondary coil by an inductive coupling. Secondary electronics are configured to convert the secondary voltage into an electric operating voltage suitable for at least one of an electric power supply mechanism and an electric consumer.

### BRIEF DESCRIPTION OF THE DRAWINGS

The present invention is described in greater detail below on the basis of embodiments and of the drawings in which:

FIG. 1 shows an exploded diagram of an embodiment of a device for transmitting electric power of a system according to the present invention which at the same time also has the function of a traditional hinge;

FIG. 2 shows an embodiment according to the present invention in a partially cutaway diagram of the wall and leaf parts in a perspective view with the primary and secondary electronics indicated schematically;

FIG. 3 shows the upper wall part and the leaf part, partially cut away in individual perspective diagrams;

FIG. 4 shows a view of the open end face of a coil body;

FIG. 5 shows the detail V in FIG. 2 in the section through the hinge axis; and

FIG. 6 shows an exploded diagram of an embodiment of a device for transmitting electric power of a system according to the present invention which serves to transmit electric power from the wall to a leaf.

### DETAILED DESCRIPTION

In an embodiment, the system according to the present invention for transmission of electric power from a wall to a leaf hingeably attached to the wall comprises primary electronics converting a power supply into a primary voltage for acting upon the primary coil, which is suitable for generating a secondary voltage by inductive coupling in the secondary coil, and having secondary electronics for converting the secondary voltage into an electric operating voltage suitable for an electric power storage mechanism and/or for an electric consumer. The electric power storage may, for example, be a battery or a capacitor, in particular an electrolyte capacitor which buffers the power peaks of the electric consumers and short-term voltage interruptions and can smooth the secondary voltage. The power supply voltage may be a line voltage, but it is also possible to use a DC voltage supplied by a sabotage-proof power pack with emergency power backing, for example. In particular when the line voltage serves as the power supply voltage, the spatial dimensions of the primary electronics may be adapted to the inside volume of a conventional flush-mounted box, for example, from which a connection of the outlet of the primary electronics to the primary coil can be accomplished with the help of cables passed through an empty pipe. The secondary electronics have spatial dimensions making them suitable for introduction into a hollow section of a leaf, for example, so that no electronic components are visible on the leaf end. If the external appearance of the wall part and the leaf part correspond to the frame and leaf hinge parts of the hinges which are used for hingeably mounting the leaf, then the system according to the present invention furthermore appears merely as another hinge, and it is impossible to see that the components requiring electric power are in the leaf.

In an embodiment of the present invention, the primary voltage can, for example, have a frequency of at least 20 kHz. This avoids the fact that other components can be induced to mechanical vibrations in the range of the audible by the electromagnetic field generated by the primary coil.

In an embodiment of the present invention, the primary frequency can, for example, be between 50 and 140 kHz. It is then far above the limit of the audible and is not yet in such a high frequency range in which emission of radio waves through feeder lines must be expected, which could interfere with radio reception in the long wavelength range.

In an embodiment of the present invention, the primary voltage acting upon the primary coil can, for example, amount to a maximum 48 V. Based on this limitation, a minimal power of 500 mW can be transmitted with the help of the system according to the present invention on the one hand, without therefore having a primary coil of a size that is a disadvantage for the intended purpose, while on the other hand, the safety measures that would be necessary to protect people from electrification at high primary voltages may be omitted because voltages up to the aforementioned maximum level are not dangerous for people.

In an embodiment of the present invention, the primary voltage can, for example, be between 3.5 and 15 V. A coil designed for this voltage range has even smaller dimensions so that it is more suitable for being accommodated in a hinge, which at the same time serves to transmit mechanical forces between the leaf and the wall, or in a device whose visual appearance corresponds to that of traditional hinges. In addition, most electric consumers provided in a leaf operate in this voltage range, so that the same components may be used for the primary coil and the secondary coil and nevertheless none of the secondary coils requires a downstream transformer. All that is necessary in this case is rectification of the alternating voltage induced in the secondary coil because this is not suitable for charging an electric power storage mechanism.

To generate the primary voltage with the required primary frequency on the wall end, an existing line voltage or a DC voltage supplied to a power pack can, for example, be converted accordingly.

To improve inductive coupling of the secondary coil to the primary coil, the primary coil can, for example, comprise a primary coil winding and a coil body made of a ferromagnetic or ferromagnetic material, which can cover the coil winding at least almost completely on the end facing the leaf part and which may be open on the opposite end face, and the secondary coil can, for example, comprise a secondary coil winding and a secondary coil body made of a ferromagnetic or ferromagnetic material that can cover the coil winding at least almost completely on the end facing the wall part and may be open on the opposite end face.

To improve coupling and also to facilitate windability of the coil, a primary coil body and/or a secondary coil body which has an inner cylindrical lateral surface about which the primary coil winding and/or the secondary coil winding is wound can, for example, be used.

In order to improve the inductive coupling of the secondary coil to the primary and also to make the coils more resistant to external influences, it can be advantageous if the primary coil body and/or the secondary coil body additionally comprise(s) an outer lateral surface arranged concentrically with the inner lateral surface. The coil winding is then surrounded and protected from the inner and outer lateral surfaces as well as the closed end face.

Because of the frequency range which the primary voltage can have, the primary coil winding and the second coil winding can, for example, consist of high-frequency cables.

The system according to the present invention may be designed so that it serves only to transmit electric power from the wall to a leaf hingeably attached to said wall about a hinge axis and not to transmit mechanical forces. The actual fastening of the leaf on the wall in such a case is accomplished only with the help of at least two additional traditional hinges. Seen from the inner lateral surface radially inward, the primary and secondary coil bodies may then be designed to be solid.

In an embodiment of the present invention, the primary and secondary coil bodies each comprise an opening extending approximately concentrically with the inner lateral surface in the direction of the hinge axis through which a bolt defining the hinge axis can be inserted. The device may then serve not only to transmit power but also to transfer mechanical forces between the leaf and the wall and thus at the same time assume the traditional function of a hinge.

In order for the bolt to act like a common core of a transformer formed with the help of the primary coil and the secondary coil to further improve the inductive coupling, it has a sleeve with ferromagnetic or ferromagnetic properties on the length covered by the primary coil and the second coil. Its length can, for example, be as close as possible to the length covered by the primary coil and by the secondary coil in order to prevent losses.

The sleeve may be pushed onto the bolt. However, the sleeve can, for example, be provided in a recess running concentrically with the longitudinal axis of the bolt. It can then, for example, be made of a plastic material with ferrite particles because in this way the unit of the bolt and the sleeve can be manufactured especially easily.

To provide a good inductive coupling between the primary coil and the secondary coil, at least one of the primary and secondary coils is displaceably mounted in the wall part and/or the leaf part by spring action against the other respective coil in the direction of the hinge axis. This measure provides that the end faces of the two coils facing one another are always in direct contact. This is important because it has surprisingly been found that even with the bolt present with the sleeve, even minor gap dimensions have a strong negative effect on the power transmission from the primary coil to the secondary coil.

The coil can, for example, have a length smaller than the outside diameter of its coil housing. In particular when the system according to the present invention should also serve to mechanical forces, the bolt can be mechanically supported over a greater length to thereby achieve the lowest possible specific load on the material.

The primary coil and the secondary coil can, for example, be designed identically; if the primary coil and the secondary coil are designed identically, the cost for production and storage of the coils can be reduced.

Experiments have shown that a power transmission of at least 500 milliwatts can be achieved at a primary voltage of 5 V and a primary frequency of approximately 120 kHz if the inductances of the primary coil and the secondary coil amount to, for example, approximately 30 μH.

To prevent parts of the device being acted upon by the primary coil voltage in the event of an internal short circuit of a coil, the primary coil and/or the secondary coil, in particular their facing end faces, can, for example, be surrounded by an electrically insulating material in a physically bonded arrangement.

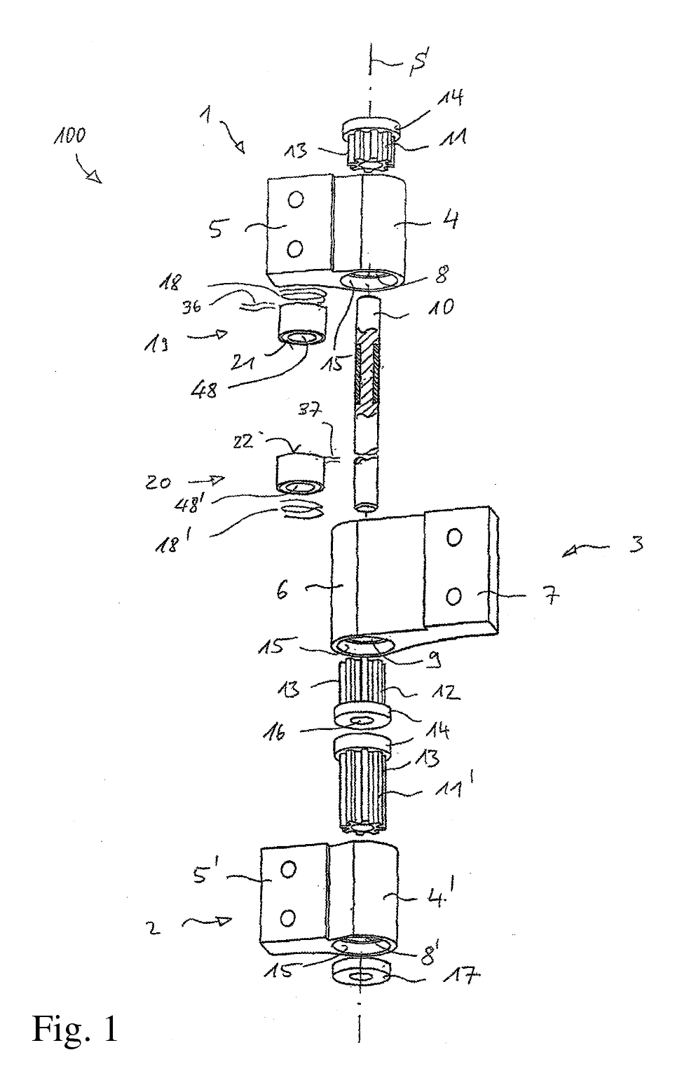

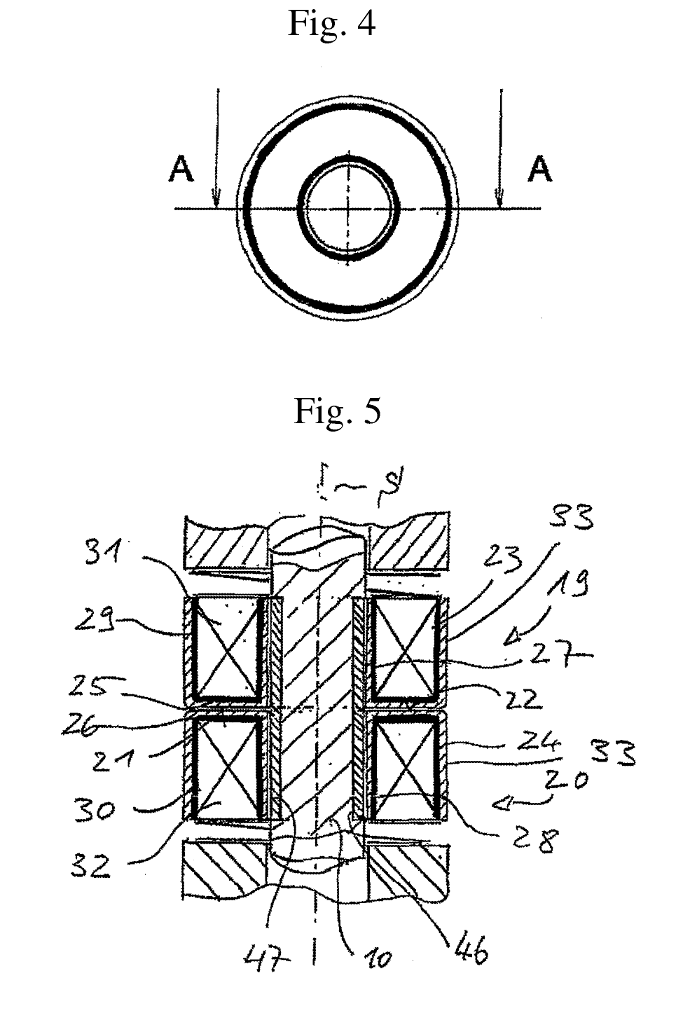

The device labeled as 100 on the whole in FIGS. 1 through 5 is designed as so-called three part hinge. It comprises an upper wall part 1 and a lower wall part 2. The two parts 1, 2 are spaced a distance apart from one another in the direction of a hinge axis S.

A leaf part 3 is arranged between the upper and lower wall parts 1, 2.

The upper and lower wall parts 1, 2 each comprise a wall hinge part 4, 4′ and a wall fastening part 5, 5′. The leaf hinge part comprises a leaf part 6 and a leaf fastening 7 accordingly.

The hinge axis S is defined by a bolt 10 passing through the wall hinges 4, 4′ and the leaf hinge part 6 in bolt receptacles 8, 8′ and 9. Bearing bushings 11, 11′ and 12 made of a plastic material, for example, based on POM with friction bearing-modifying additives, which have proven successful for use as bearing bushings with hinges serve to support the bolt 10 in the bolt receptacles 8, 8′, 9. The bearing bushings 11, 11′ and 12 have radial protrusions 13 extending in parallel with the hinge axis S. The diameter of the circle connecting the radial protrusions 13 to one another is adapted to the inside diameter of the bolt receptacle 8, 8′, 9 such that the bearing bushings 11, 11′ and 12 engage in the respective bolt receptacles without any play. Ring-shaped end areas 14, which protrude radially slightly above the radial protrusions 13, are integrally molded on the upward facing end of the bearing bushing of the lower wall hinge part 2, at the upper end of the bearing bushing 11 of the upper wall hinge part 1 and at the lower end of the bearing bushing 12 of the leaf part 3, protruding slightly beyond the radial protrusions 13. They rest in a suitably dimensioned radial enlargement 15 in the respective bolt receptacle 8, 8′, 9 and thus seal the bolt receptacles form the outside against penetration of impurities. In addition, the end areas 14 of the bearing bushings 11′ of the lower wall part 2 and the bearing bushing 12 of the leaf part 3 form supports by means of which forces acting in the direction of the hinge axis are initiated from the leaf part 3 into the lower wall part 2. Furthermore, the bearing bushings 11, 11′, 12 have inner boreholes, the diameter of which is adapted to the diameter of the bolt 10 such that it is accommodated rotatably but at least essentially without play by the bearing bushings 11, 11′, 12.

A bearing disk 17 whose dimensions correspond to the end areas 14 and which is inserted into a radial enlargement 15 in the lower wall part forms the lower closure of the lower wall part 2.

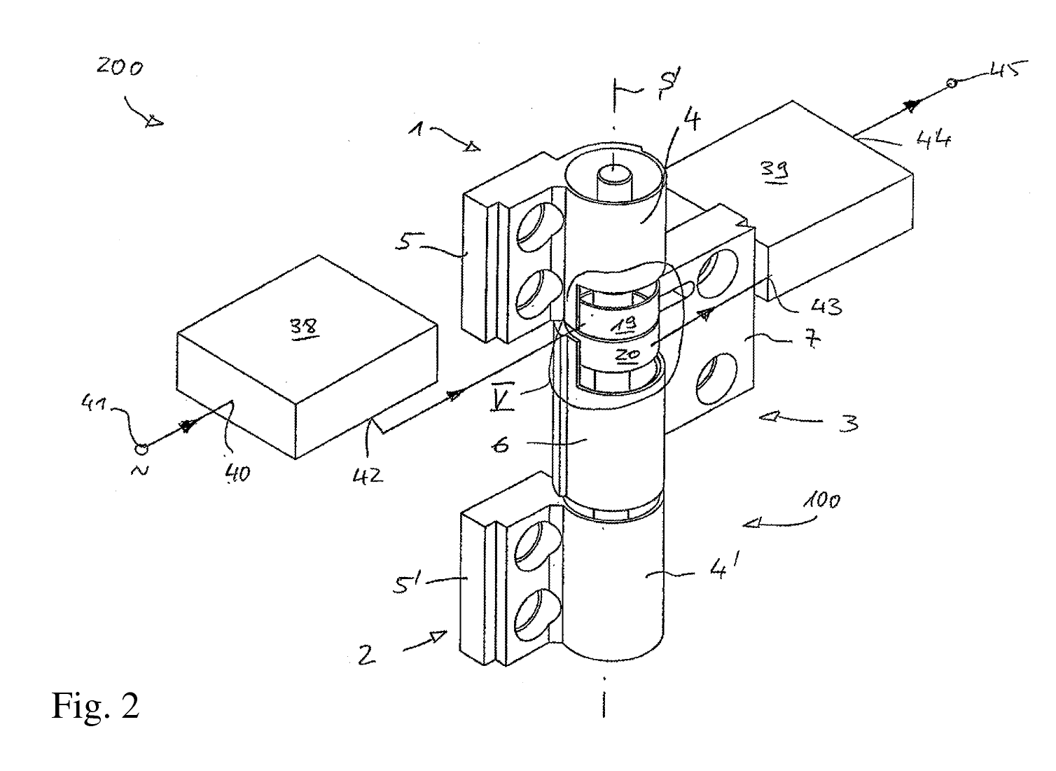

The length of the bearing bushing 11′ corresponds almost to the length of the bolt receptacle 8′ of the lower wall part 2, whereas the bearing bushings 11, 12 are designed to be only approximately half as long as the bolt receptacle 8 of the upper wall part 1 and/or the bolt receptacle 9 of the leaf part 3. In the remaining clearance of the bolt receptacles 8, 9, a primary coil 19 and a secondary coil 20 are inserted into the remaining clearance. There is one compression spring 18, 18′ between the primary coil 19 and the bearing bushing 11 and another between the secondary coil 20 and the bearing bushing 12. These compression springs provide that the two primary and secondary coils 19, 20 are in contact with one another at their end faces 21, 22, which is discernible in FIGS. 2 and 5 in particular.

The primary coil 19 and the secondary coil 20 are designed identically but in opposite directions with respect to the hinge axis S. They include a primary coil body 23 and a secondary coil body 24 made of ferromagnetic or ferromagnetic material. The coil bodies 23, 24 each have a closed end wall 25, 26 on their facing sides, each having a central through-hole 48, 48′ for the passage of the hinge bolt. An inner jacketing wall 27, 28 and an outer jacketing wall 29, 30 extend concentrically with the hinge axis S in opposite directions from the end walls 25, 26. The coil bodies 23, 24 are open on the sides opposite the end walls 25, 26.

The primary and secondary coil windings 31, 32, which are wound around the inner jacketing walls 27, 28 are situated in the interior of the coil bodies 24, 25. High-frequency cables are used for the coil windings.

The coil bodies 23, 24 are each sheathed in a physically bonded connection with an electrically nonconductive plastic material.

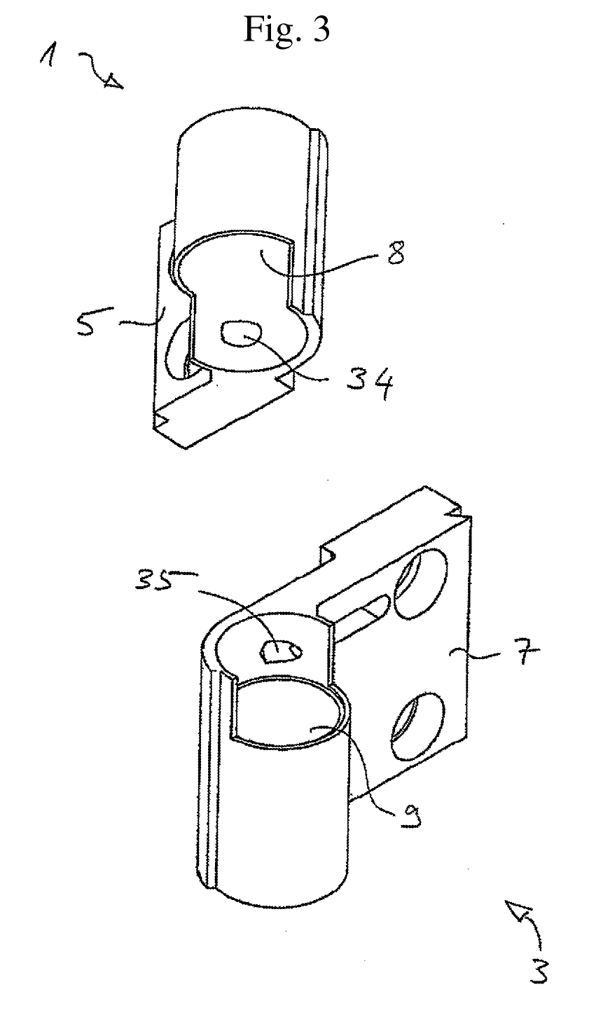

As shown in particular by FIGS. 1 and 3, channels 34, 35 extend from the hinge bolt receptacles 8, 9 into the frame mounting part 5 and/or the leaf mounting part 7 are provided on the upper wall part 1 and on the leaf part 3. They serve to carry the connecting lines 36, 37 of the primary and/or secondary coils 19, 20.

FIG. 2 shows a device 100 with primary electronics 38 and secondary electronics 39 to form a system according to the present invention for transmission of electricity from a wall to a leaf attached to this wall. The primary electronics 38 of this system 200 is connected at its input 40 to a line voltage 41. The primary electronics converts the line voltage into a voltage of maximum 48 V and a frequency between 20 and 140 kHz, which is supplied at the output 42. The latter is connected to the primary coil 19. However, it is also possible to provide the primary electronics with an inverter and to connect it to a DC voltage source.

Since the primary and secondary coils 19, 20 are designed identically, the same voltage is applied to the input 43 of the secondary electronics 39, which is connected to the secondary coil 20, as to the output 42. In the secondary electronics 39 this voltage is converted into a voltage suitable for operating an electric consumer or an electric power storage mechanism 45 connected to the output 42 of the secondary of the secondary electronics 39.

To improve the inductive coupling between the primary coil 19 and the secondary coil 20, the bolt 10 has a recess 46 which runs concentrically with the hinge axis 6. This recess contains a sleeve 47 made of a plastic material having finished particles incorporated into it. The length of the sleeve 47 is such that it almost exactly matches the length of the coil package consisting of the primary coil and the secondary coil 19, 20.

The system according to the present invention was tested with the following experimental setup: coils with a coil winding of 50 windings of a high-frequency cable with a diameter of 0.05 mm were used as the primary and secondary coils 19, 20. The coil inductance was approximately 30 pH. The primary voltage supplied with the primary electronics was effectively approx. 5 V with a primary frequency of 120 kHz. The secondary electronics design was such as to supply a DC voltage of approximately 5 V at the output. A power of up to 750 mW could be supplied at the secondary side.

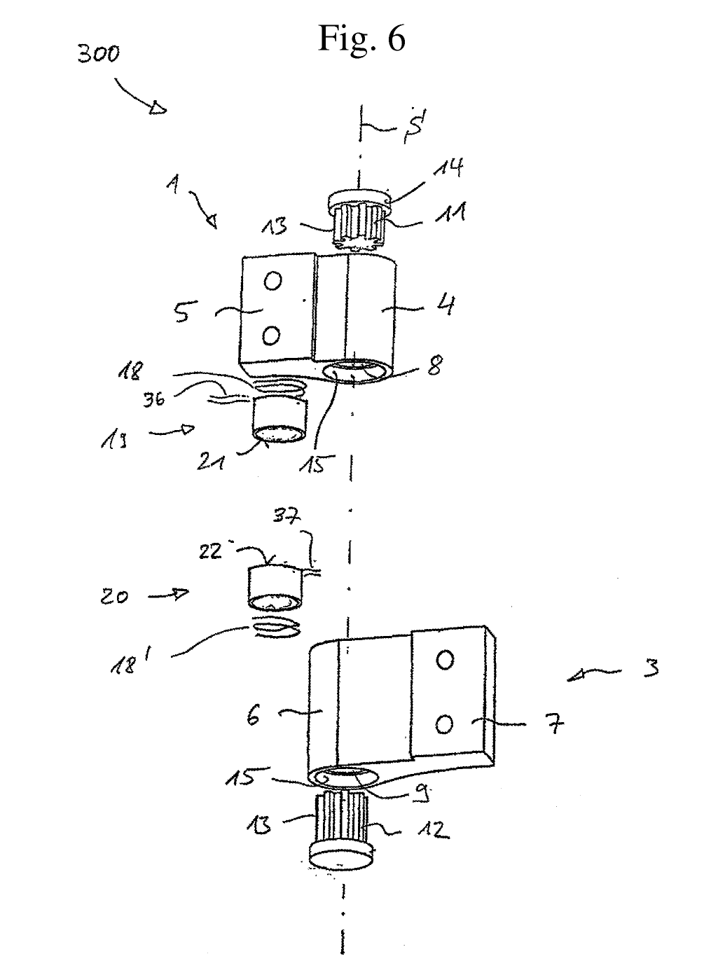

Another exemplary embodiment of a device 300 for use in a system according to the present invention is shown in FIG. 6. For components of the same function, the same reference numerals are used as for the device 100. To avoid repetition, reference should be made to their description above.

The device 300 serves exclusively to transmit electric power from a wall part 1 into a leaf part 3. Therefore it is always used in addition to traditional hinges with a wall/leaf arrangement.

This device 300 thus does not have the bolt 10. Accordingly the bearing bushings 11, 12 are not provided with a borehole. They are adapted to the receptacles 8, 9, so that the can be pressed into them, creating a force locking engagement, so that the compression springs 18, 18′ can be supported on the facing ends.

The primary and secondary coils 19, 20 thus have coil bodies which do not have a central through-hole for the passage of the bolt, in contrast with the coil bodies in device 100, but instead are designed there as a solid body of ferromagnetic material.

When this device is mounted on a wall/door arrangement comprising traditional hinges, this is done in such a way that the hinge parts 4, 6 do not abut against one another with their facing end but instead there remains a gap which is bridged by the primary and secondary coils pressed against one another under the spring force at the ends. These can also be displaced across the hinge axis S in the absence of a bolt passing through them, so an adjustment of the leaf in the wall section is performed in all three directions in space without requiring a special adjustment of the device to do so.

The present invention is not limited to embodiments described herein; reference should be had to the appended claims.

### LIST OF REFERENCE NUMERALS

100, 300 Device
200 System
1 Upper wall part
2 Lower wall part
3 Leaf part
4, 4′ Wall hinge part
5, 5′ Wall fastening part
6 Leaf hinge part
7 Leaf fastening part
8, 8′ Bolt receptacle
9 Bolt receptacle
10 Bolt
11, 11′ Bearing bushing
12 Bearing bushing
13 Protrusions
14 End areas
Enlargement
16 Boreholes
17 Bearing disk
18, 18′ Compressive spring
19 Primary coil
20 Secondary coil
21 End face
22 End face
23 Primary coil body
24 Secondary coil body
25 End wall
26 End wall
27 Internal jacketing wall
28 Internal jacketing wall
29 External jacketing wall
30 External jacketing wall
31 Primary coil winding
32 Secondary coil winding
33 Plastic material
34 Channel
35 Channel
36 Connecting line
37 Connecting line
38 Primary electronics
39 Secondary electronics
40 Input
41 Line voltage
42 Output
43 Input
44 Output
45 Consumer/energy storage mechanism
46 Recess
47 Sleeve
48, 48′ Through-holes

What is claimed is:

1-20. (canceled)

21. A system for transmitting electric power from a wall to a leaf hingeably fastened to the wall about a hinge axis, the system comprising
a wall part fastened on the wall;
a leaf part fastened on the leaf;
a primary coil provided on the wall part;
a secondary coil provided on the leaf part;
primary electronics configured to convert a power supply voltage into a primary voltage so as to act upon the primary coil, the primary voltage being suitable to generate a secondary voltage in the secondary coil by an inductive coupling; and
secondary electronics configured to convert the secondary voltage into an electric operating voltage suitable for at least one of an electric power supply mechanism and an electric consumer.

22. The system as recited in claim 21, wherein the primary electronics comprises a converter configured to generate a primary voltage having a frequency between 20 kHz and 140 kHz and an effective value of <48 V.

23. The system as recited in claim 22, wherein the effective value of the primary voltage is between 3.5 and 15 V.

24. The system as recited in claim 21, wherein the secondary electronics comprises at least one rectifier circuit.

25. The system as recited in claim 21, wherein the primary coil comprises a primary coil winding and a primary coil body each made of a ferromagnetic or ferromagnetic materials, and the secondary coil comprises a secondary coil winding and a secondary coil body each made of a ferromagnetic or ferromagnetic materials.

26. The system as recited in claim 25, wherein the primary coil body is configured to substantially cover the primary coil winding on an end facing the leaf hinge part and to be open on an opposite end face, and the secondary coil body is configured to substantially cover the coil winding on an end facing the frame hinge part and to be open on an opposite end face.

27. The system as recited in claim 26, wherein at least one of the primary coil body and the secondary coil body has an inner cylindrical jacketing wall about which the respective primary coil winding and secondary coil winding is wound.

28. The system as recited in claim 27, wherein at least one of the primary coil body and the secondary coil body comprises an outer jacketing wall which is arranged concentric with the inner cylindrical jacketing wall.

29. The system as recited in claim 25, wherein the primary coil winding and the secondary coil winding are made of a high-frequency cable.

30. The system as recited in claim 25, further comprising a bolt configured to define the hinge axis, wherein the primary coil body and the secondary coil body each comprise a first opening configured to be approximately concentric with the inner cylindrical jacketing wall in a direction of the hinge axis, the first opening being configured so as to have the bolt be insertable therethrough.

31. The system as recited in claim 30, wherein the bolt comprises a sleeve with ferromagnetic properties along a length covered by the primary coil and by the secondary coil.

32. The system as recited in claim 31, wherein the bolt comprises a recess that runs concentric to a longitudinal axis of the bolt, and wherein the sleeve is provided in the recess.

33. The system as recited in claim 31, wherein the sleeve is made of a plastic material comprising ferrite particles.

34. The system as recited in claim 21, wherein at least one of the primary coil and the secondary coil is mounted spring-loaded in at least one of the wall part and the leaf part so it to be displaceable against the other respective primary coil or secondary coil in a direction of the hinge axis.

35. The system as recited in claim 21, wherein a length of at least one of the primary coil and the secondary coil in a direction of the hinge axis is smaller than an outside diameter of a respective coil housing of the primary coil or of the secondary coil.

36. The system as recited in claim 21, wherein the primary coil and the secondary coil are configured identically.

37. The system as recited in claim 21, wherein at least one of the primary coil and the secondary coil have an inductively of between 1 μH and 100 μH.

38. The system as recited in claim 37, wherein the inductively is approximately 30 μH.

39. The system as recited in claim 21, wherein the primary coil and the secondary coil are configured to have an effective maximum voltage of 48 V.

40. The system as recited in claim 21, wherein at least one of the primary coil and the secondary coil are sheathed by a form-fitting electrically insulating material.

41. The device as recited in claim 40, wherein the respective coil faces of the primary coil and of the secondary coil facing each other are sheathed by a form-fitting electrically insulating material.
